(19) United States
(12) Patent Application Publication
(10) Pub. No.: US 2010/0143706 A1
(43) Pub. Date: Jun. 10, 2010

(54) POLYIMIDE LAMINATE AND A METHOD OF FABRICATING THE SAME

(75) Inventors: Der-Jen Sun, Taoyuan County (TW); Yen-Huey Hsu, Taoyuan County (TW); Ming-Hsiang Chen, Taoyuan County (TW); Hsiu-Yeh Hu, Taoyuan County (TW)

Correspondence Address: BRIAN M. MCINNIS, 12th Floor, Ruttonjee House, 11 Duddell Street, Hong Kong, HK

(73) Assignee: MORTECH CORPORATION, Taoyuan County (TW)

(21) Appl. No.: 12/633,776

(22) Filed: Dec. 8, 2009

(30) Foreign Application Priority Data
Dec. 9, 2008 (TW) 97147890

(51) Int. Cl. B32B 5/16; C25D 5/56; B32B 15/08

(52) U.S. Cl. 428/329; 205/165; 428/458

(57) ABSTRACT

Disclosed herein are a polyimide laminate and a method for fabricating the same. In the disclosed method, a polyimide film having a thermally-conductive filler distributed homogenously therein is prepared, the polyimide film is characterized in having a thermal conductivity greater than 0.3 W/m-° C. Then, at least one metal film is subsequently deposited on one or both sides of the polyimide film by electroplating, electroless plating, evaporation, sputtering or lamination and thereby forming the desired polyimide laminate.

### RELATED APPLICATIONS

This application claims priority to Taiwan Application Serial Number 97147890, filed Dec. 9, 2008, which is herein incorporated by reference.

### BACKGROUND

1. Field of Invention

The present disclosure in general relates to a circuit board and a method to of fabricating the same. More particularly, the present disclosure is related to a polyimide laminate and a method of fabricating the same.

2. Description of Related Art

With the prevalence of flexible circuit boards (FCPs) over the known printed circuit boards (PCB) in electronic communication devices, FCPs market has enjoyed a rapid growth in recent years. Further, being light weighted and easy to carry also contribute the growing popularity of FCPs in meeting product demands of end applications.

A flexible circuit board laminate is usually composed of a plastic substrate, and a plurality of metal layers disposed thereon, wherein each of the metal layers includes wires for connecting other circuit devices. Heat is commonly generated in a typical metal film producing process, if not dissipated properly, would accumulated on the substrate and eventually deteriorates the substrate, particularly, the flexible substrate.

In view of the above, there exists in this art a need of an improved flexible substrate, which exhibits improved thermal conductivity and may redirect the heat generated during the manufacturing process to other heat-dissipating elements so as to reduce the temperature to a desired level. The improved flexible substrate of the present disclosure may be applied to the manufacturing process of metal films.

### SUMMARY

In view of the above, the objective of this disclosure aims to provide an improved polyimide laminate and a method of fabricating the same.

In the first aspect, the disclosure provides a modified of fabricating a polyimide laminate. The method includes steps of: forming a polyimide film having a thermally conductive filler distributed homogeneously therein with the thermally conductive filler being about 10-90% by weight of the polyimide solid is and thereby rendering the polyimide film having a thermal conductivity greater than 0.3 W/m-° C.; and forming at least one metal layer on one side of the polyimide film.

The at least one metal layer is made of any of Pd, Cu, Ni, Fe Al, or a combination thereof.

The thermally conductive filler has a thermal conductivity greater than 10 W/m-° C. and is any of a metal oxide, a metal nitride, carbon, silicon carbide or ceramic powders. The metal oxide may be aluminum oxide, and the metal nitride may be any of aluminum nitride, boron nitride, a sintered form thereof, or a combination thereof.

The at least one metal layer may be formed by electroplating, electroless plating, sputter deposition, vapor deposition or lamination.

In one example, a layer of Pd formed by electroless plating and a layer of Cu formed by electroplating are deposited in sequence on one side of the polyimide film.

In another example, a layer of Ni and a layer of Cu respectively formed by sputter deposition, and another layer of Cu formed by electroplating are deposited in sequence on one side of the polyimide film.

In still another example, a layer of Ni formed by vapor deposition, and a layer of Cu formed by electroplating are deposited in sequence on one side of the polyimide film.

In still another example, a layer of Cu is laminated on one side of the polyimide film.

In another embodiment of the disclosed method, at least one metal layer is respectively deposited on each side of the polyimide film. In one example, a layer of Pd formed by electroless plating and a layer of Cu formed by electroplating are respectively deposited in sequence on each side of the polyimide film. In another example, a layer of Ni and a layer of Cu respectively formed by sputter deposition, and another layer of Cu formed by electroplating are respectively deposited in sequence on each side of the polyimide film. In still another example, a layer of Ni formed by vapor deposition, and a layer of Cu formed by electroplating are respectively deposited in sequence on each side of the polyimide film. In still another example, a layer of Cu is laminated on each side of the polyimide film.

In a second aspect of this disclosure, a polyimide laminate having at least one metal layer deposited on one or two sides of a polyimide film is provided. The polyimide film has a thermal conductivity of greater than 0.3 W/m-° C.

In one embodiment, the polyimide laminate has at least one metal layer deposited on one side of the polyimide film. In one example, the polyimide laminate includes a layer of Pd and a layer of Cu deposited in sequence on one side of the polyimide film. In another example, the polyimide laminate includes a layer of Ni, a first layer of Cu and a second layer of Cu deposited in sequence on one side of the polyimide film. In still another example, the polyimide laminate includes a layer of Ni and a layer of Cu deposited in sequence on one side of the polyimide film. In still another example, the polyimide laminate includes a layer of Cu laminated on one side of the polyimide film.

In another embodiment, the polyimide laminate has at least one metal layer respectively deposited on each side of the polyimide film. In one example, each side of the polyimide laminate includes a layer of Pd and a layer of Cu deposited in sequence on the polyimide film. In another example, each side of the polyimide laminate includes a layer of Ni, a first layer of Cu and a second layer of Cu deposited in sequence on the polyimide film. In still another example, each side of the polyimide laminate includes a layer of Ni and a layer of Cu deposited in sequence on the polyimide film. In still another example, each side of the polyimide laminate includes a layer of Cu laminated on the polyimide film.

These and other features, aspects, and advantages of the present disclosure will become better understood with reference to the following description and appended claims.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure. In the drawings,

FIG. 1 is a schematic diagram illustrating an apparatus for fabricating the polyimide film in according to one embodiment of this disclosure.

### DETAIL DESCRIPTION OF ILLUSTRATED EMBODIMENTS

Reference will now be made in detail to the preferred embodiments of the disclosure, examples of which are illustrated in the accompanying drawings. Wherever possible, the same reference numbers are used in the drawings and the description to refer to the same or like parts.

Embodiments of the present disclosure are directed to a method of fabricating a polyimide laminate. The method includes steps of: forming a polyimide film having a thermally conductive filler distributed homogeneously therein with the thermally conductive filler being about 10-90% by weight of the polyimide solid and thereby rendering the polyimide film having a thermal conductivity greater than 0.3 W/m-° C.; and forming at least one metal layer on one side of the polyimide film.

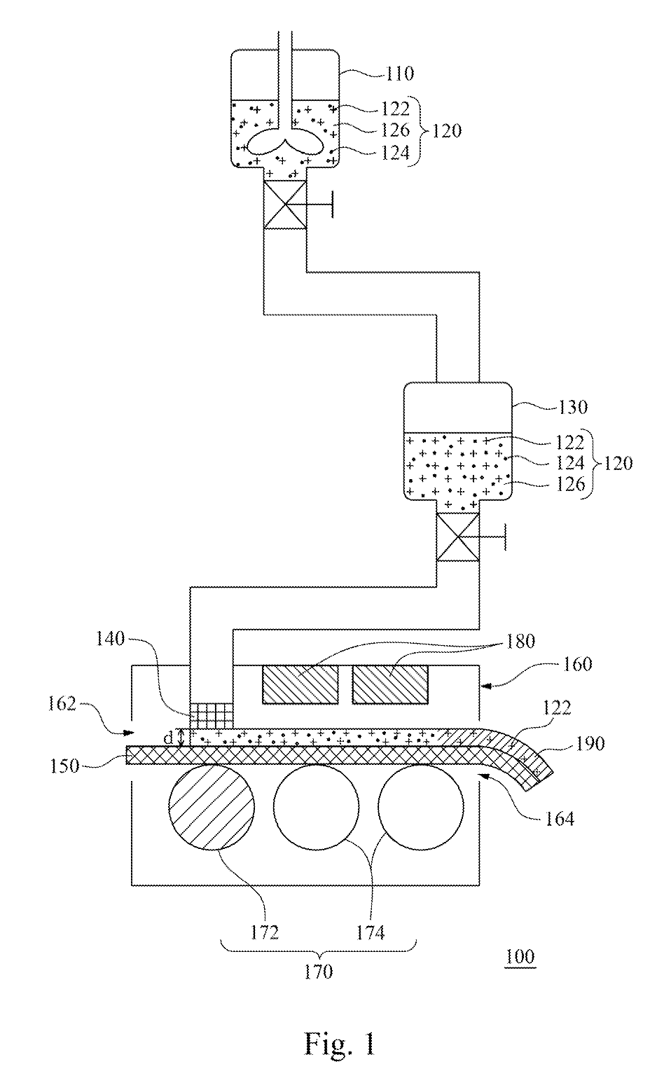

FIG. 1 is a schematic diagram illustrating an apparatus 100 for performing the method of this disclosure. A polyamic acid solution 120 is prepared in a reactor 110 of the apparatus 100. The polyamic acid solution 120 may be made by any suitable procedures, for example, one of the reactants for producing polyamic acid 124, the aromatic diamine, is dissolved in a solvent 126, followed by the addition of the other reactant, aromatic tetracarboxylic dianhydride, and a thermally conductive filler 122. The two reactants in the mixture, the aromatic diamine and the aromatic tetracarboxylic dianhydride, are allowed to react and form polyamic acid 124, with the thermally conductive filler 122 being homogeneously distributed within the mixture of the polyamic acid 124 and the solvent 126.

The method of making the polyamic acid solution 120 or polyamic acid 124 has been disclosed in a published Taiwan patent application No: TW 200914502 filed by the same applicant on Sep. 29, 2007 and published on Apr. 1, 2009, the disclosure thereof is incorporated herein by reference.

Suitable aromatic diamine for use in the disclosed method includes, but is not limited to, 1,4-diaminobenezene, 1,3-diaminobenezene, 4,4′-oxydianiline, 3,4′-oxydianiline, 4,4′-methylene dianiline, N,N′-diphenylethylenediamine, diaminobenzophenone, diaminodiaphenyl sulfone, 1,5-naphthalene diamine, 4,4′-diaminodiphenyl sulfide, 1,3-bis(3-aminophenoxy)benzene, 1,4-bis(4-aminophenoxy)benzene, 1,3-bis(4-aminophenoxy)benzene, 2,2-bis[4-(4-aminophenoxy)phenoxy]propane, 4,4′-bis(4-aminophenoxy)biphenyl, 4,4′-bis(3-aminophenoxy)biphenyl, 1,3-bis(3-aminopropyl)-1,1,3,3-tetramethyldisiloxane, 1,3-bis(3-aminopropyl)-1,1,3,3-tetraphenyldisiloxane, 1,3-bis(aminopropyl)-dimethyldiphenyldisiloxane or a combination thereof. Suitable aromatic tetracarboxylic dianhydride for use in the disclosed method includes, but is not limited to, 1,2,4,5-benzene tetracarboxylic dianhydride, 3,3′,4,4′-biphenyl tetracarboxylic dianhydride, 4,4′-oxydiphthalic anhydride, benzophenone tetracarboxylic dianhydride, 3,3′,4,4′-biphenyl sulfone tetracarboxylic dianhydride, 1,2,5,6-nathalene tetracarboxylic dianhydride, Naphthalene tetracarboxylic dianhydride, Bis(3,4-dicarboxyphenyl)dimethylsilane dianhydride, 1,3-bis(3,4-phthalic anhydride)-tetramethyl disiloxane or a combination thereof.

The aromatic diamine and the aromatic tetracarboxylic dianhydride may be used in a molar ratio of between about 1.1:1 to about 0.9:1.

Suitable solvent that may be used in the present disclosure includes, but is not limited to, N,N-dimethyl formamide (DMF), dimethyl acetamide (DMAc), dimethyl sulfoxide (DMSO), N-methyl-2-pyrrolidone (NMP), or a combination thereof.

Suitable thermally conductive filler that may be employed in the disclosed method may be an inorganic material having a thermal conductivity greater than 10 W/m° C., and may be any of a metal oxide such as aluminum oxide; a metal nitride such as aluminum nitride, boron nitride, a sintered form thereof or a combination thereof; a carbon material such as carbon, carbon black, graphite or a carbon nanotube; silicon carbide; ceramic powders or a combination thereof. In one example, aluminum oxide is employed as the thermally conductive filler. The thermally conductive filler is used in an amount of about 10-90% by weight of the polyimide solid, such as 10, 20, 30, 40, 50, 60, 70, 80, or 90% by weight of the polyimide solid.

The polyamic acid solution 120 thus prepared may be optionally stored in a reservoir 130 until further use. In the process of producing the polyimide film, a constant amount of the polyamic acid solution 120 is delivered continuously from the reservoir 130 to a delivered head 140, while a steel strip 150 is continuously fed through an inlet 162 of a film-producing device 160 by a driving means 170 and acts as a carrier for carrying the constant amount of the polyamic acid solution 120 delivered from the delivered head 140 to the steel strip 150 for producing the polyimide film. The driving means includes a wheel 172 and a supporting cylinder 174.

The delivered head 140 may be a head suitable for blade coating, slot coating, or extrusion coating. The polyamic acid solution 120 may be driven by weight or by pressure and is delivered continuously in a constant amount from the head 140 to the surface of the rotating steel strip 150 driven by the driving means 170. The head 140 is set to be separated from the surface of the rotating steel strip 150 by a distance “d”, which is about 60-1500 μm, so as to allow the polyamic acid solution 120 in various thickness to be held on the surface of the steel strip 150 and subsequently form polyimide films in various is thickness. By controlling the distance “d” or the pressure for delivering the polyamic acid solution 120, the purpose of forming polyamic acid solution 120 in various thicknesses may be achieved easily.

The polyamic acid solution 120 that is held on the surface of the steel strip 150 is subsequently heated to form polyimide film thereon. In operation, the steel strip 150 carried thereon the polyamic acid solution is driven by the driving means 170 and passes the heating device 180, so that the polyamic acid solution may be heated at a temperature between 80-400° C. and thereby forms the polyimide film 190, which is subsequently outputted from the outlet 164.

The outputted polyimide film 190 may then be used in a metallization process to fabricate the desired polyimide laminate.

The metallization process may be performed on either one side or both sides of the polyimide film 190 fabricated by the method described above. At least one metal layer is deposited on either one or both sides of the polyimide film 190 by any of a method, which includes but is not limited to, electroplating, electroless plating, sputter deposition, vapor deposition, or lamination. The thickness of each metal layer may be adjusted by the specification of the intended application and any person having ordinary skill in the related art may adjust the process parameters to determine the most suitable condition for depositing each metal layer without undue experimentation.

Suitable metal for use in the metallization process includes, but is not limited to, Pd, Cu, Al, Ni, Fe, or a combination thereof.

In one embodiment, the metallization process is performed on only one side of the polyimide film 190, In one example, a layer of Pd formed by electroless plating and a layer of Cu formed by electroplating are deposited in sequence on one side of the polyimide film. In another example, a layer of Ni and a layer of Cu respectively formed by sputter deposition, and another layer of Cu formed by electroplating are deposited in sequence on one side of the polyimide film. In still another example, a layer of Ni formed by vapor deposition, and a layer of Cu formed by electroplating are deposited in sequence on one side of the polyimide film. In still another example, a layer of Cu is laminated on one side of the polyimide film.

In another embodiment of the disclosed method, the metallization process is performed on both sides of the polyimide film 190, that is, at least one metal layer is respectively deposited on each side of the polyimide film. In one example, each side of the polyimide film includes in sequence: a layer of Pd formed by electroless plating and a layer of Cu formed by electroplating. In another example, each side of the polyimide film includes in sequence: a layer of Ni and a layer of Cu respectively formed by sputter deposition, and another layer of Cu formed by electroplating. In still another example, each side of the polyimide film includes in sequence: a layer of Ni formed by vapor deposition, and a layer of Cu formed by electroplating. In still another example, a layer of Cu is laminated on each side of the polyimide film.

### Example

### The Fabrication of a Polyimide Laminate

### 1. The Preparation of a Polyimide Film

Suitable amounts of p-phenylene diamine and diamino diphenyl ether as indicated in Table I were added in N-methyl pyrrolidone; then aluminum oxide was added and the mixture was continuously stirred for 1 hour. 1,2,4,5-benzene tetracarboxylic dianhydride and 3,3′,4,4′-biphenyl tetracarboxylic dianhydride were slowly added to the solution and the mixture was stirred for 6 hours to form the polyamic acid solution. The polyamic acid solution was then delivered continuously in a constant amount to the surface of the steel strip 150 of the apparatus 100 as depicted in FIG. 1, and heated at a temperature of about 80-400° C. under an atmosphere of nitrogen to form a polyimide film with a thickness about 25 μm. The polyimide film was then taken out from the steel strip 150 after its temperature returned to room temperature. The polyimide film of examples 1 and 2 were about 19.23% and 19.85% by weight of the polyamic acid solid; and the thermal conductivity, water absorption activity and electrical property of the polyimide film of examples 1 and 2 are provided in Table II.

### Comparative Examples 1 and 2

A polyimide film without a thermally-conductive filler distributed therein was manufactured by use of the ingredients indicated in Table I in according to the steps described above, except no aluminum oxide was included. The polyimide film of comparative examples 1 and 2 were about 16% and 19.85% by weight of the polyamic acid solid; and the thermal conductivity, water absorption activity and electrical property of the polyimide film of comparative examples 1 and 2 are provided in Table II.

TABLE I

| | | | Comparative | Comparative |
|---|---|---|---|---|
| | Example 1 | Example 2 | Example 1 | Example 2 |
| p-phenylene diamine (g) | 8.94 | 8.67 | 8.94 | 8.67 |
| diamino diphenyl ether (g) | 6.62 | 6.42 | 6.62 | 6.42 |
| N-methyl pyrrolidone (g) | 252 | 252 | 252 | 252 |
| Aluminum oxide (g) | 12 | 14.4 | 0 | 0 |
| 1,2,4,5-benzene | 3.57 | 3.83 | 3.57 | 3.83 |
| tetracarboxylic | | | | |
| dianhydride (g) | | | | |
| 3,3′,4,4′-biphenyl | 28.88 | 29.07 | 28.88 | 29.07 |
| tetracarboxylic | | | | |
| dianhydride (g) | | | | |
| Polyimide (% of | 19.23 | 19.85 | 16 | 19.85 |
| polyamic acid solid) | | | | |

TABLE II

| | | | Comparative | Comparative |
|---|---|---|---|---|
| | Example 1 | Example 2 | Example 1 | Example 2 |
| Thermal conductivity (W/m-° C.) | 0.5 | 0.6 | 0.17 | 0.17 |
| Water absorption activity (%) | 2.1 | 1.7 | 2.8 | 3.2 |
| Bulk Resistance (Ω cm) | 10¹³ | 10¹³ | 10¹³ | 10¹³ |
| Surface Resistance (Ω) | 10¹³ | 10¹³ | 10¹³ | 10¹³ |
| Breakdown Voltage (KV) | 5.5 | 4.5 | 6 | 5.8 |

It is clear from Tables I and II, with the addition of thermally conductive fillers such as aluminum oxide in the polyamic acid solution, the thermal conductivity of the resulted polyimide film would increase from about 0.17 W/m-° C. to about 0.5 or 0.6 W/m-° C. In other words, the thermal conductivity of the polyimide film increased with the inclusion of thermally conductive fillers there within.

Further, the water absorption activity of the polyimide film decreased with the inclusion of aluminum oxide there within the film, thereby rendering the film exhibiting better dielectric activity that complied with the specification of a high frequency circuit board.

As to the electrical property of the polyimide film, it remained relatively the same with or without the addition of aluminum oxide, with the bulk and surface resistance being 10¹³Ω and 10¹³ Ω·cm, respectively. Further, the break down voltage also remained at the level of about 2 kV.

### 2. The Preparation of Polyimide Laminate

### 2.1 Forming Metal Layers on Polyimide Film of Example 1 or 2 by Electroplating

The polyimide film of Example 1 or 2 was first cleaned with a washing solution containing permangant ions, and then with a reducing agent. The cleaned polyimide film of Example 1 or 2 was then immersed in a preparative solution, which contained polymeric electrolytes such as polyethylene imidazole that contains a tetra-valence metal ion.

The polyimide film of Example 1 or 2 was first plated with a layer of precious metal (such as Pd) by immersion the polyimide film in a electrolyte containing therein a precious metal ion gel and a reducing agent. The precious metal ion gel is a gel containing palladium ions. The reducing agent may be ascorbic acid, biphenyl, hydroxylamine or a derivative thereof, or formaldehyde. The polyimide film of Example 1 or 2 was placed in a cell containing therein the precious metal ion gel, the reducing agent was then poured in to start the electroless plating procedure, and a thin layer of Pd was respectively formed on each side of the polyimide film of Example 1 or 2.

This polyimide film having a thin layer of Pd respectively formed on each side was then placed in an electroplating cell for plating a thin layer of Cu on each side. Alternatively, a thin layer of copper may be electroplated on only one side of the polyimide film. The electrolyte for copper plating was copper sulfate or copper pyrophosphate, and the electrolyte solution was mildly stirred during plating. The plated Cu layer was about 50 μm in thickness. It is to be noted that in general the plating solution for industrial use usually contains leveling agent, gloss-enhancer or the like, which may cause damage to the polyimide film, hence may not be used in this invention.

After the Cu plating was completed, the thus obtained polyimide laminate was then subjected to etching process to form desired circuit pattern thereon, and a final layer of Au was formed on top of the circuit pattern to protect the circuit pattern from oxidation.

### 2.2 Forming Metal Layers on Polyimide Film of Example 1 or 2 by Sputter Deposition and Electroplating

The polyimide film of Example 1 or 2 was pre-cleaned in a vacuum chamber by corona discharge or plasma etching. Then, a thin layer of Ni was sputter deposited on either one or both sides of the polyimide film with a thickness being controlled to be in the range of about 50 Å to 500 Å; followed by sputter deposition a layer of Cu thereon. The Cu layer may be formed on either one or both sides of the polyimide film.

Then, another layer of Cu was electroplated in accordance with the procedures described above in section 2.1. Similarly, the layer of Cu may be electroplated on either one or both sides of the polyimide film with a thickness of about 50 μm. The thus formed polyimide laminate was then proceeded to form desired circuit pattern and an outer most layer of Au according to steps described in section 2.1.

### 2.3 Forming Metal Layers on Polyimide Film of Example 1 or 2 by Vapor Deposition

A layer of Ni was formed on either one or both sides of the polyimide film of example 1 or 2 by vapor deposition. The thickness of the Ni layer was less than 500 Å, and preferably between 50 Å to 300 Å. Alternatively, Fe or Al may be used in place of Ni.

Then, a layer of Cu was electroplated thereon in accordance with the steps described in section 2.1. Similarly, the Cu layer may be electroplated on either one or both sides of the polyimide film. The thus formed polyimide laminate was then subjected to etching process to form desired circuit pattern thereon and an outer most Au layer to protect the circuit pattern from oxidation.

### 2.4 Forming Metal Layers on Polyimide Film of Example 1 or 2 by Lamination

The polyimide film of example 1 or 2 was laminated with a layer of Cu in accordance with known procedures for lamination. The layer of Cu may be formed by electroplating or by rolling milling with a thickness between about 5 μm to 50 μm, preferably between about 5 μm to 35 μm, and a smooth surface. The layer of Cu may be replaced by a layer of Al or Fe. The thus formed polyimide laminate may be stored in rolls until further uses.

### INDUSTRIAL APPLICATION

The present disclosure provides an improved method of fabricating a polyimide laminate. The polyimide laminate includes a polyimide film having thermally conductive filler homogeneously distributed therein, and at least one metal layer formed on either one or both sides of the polyimide film. The thermally conductive filler homogeneously distributed within the polyimide film renders the film with good thermal conductivity and therefore may prevent excess heat generated during any subsequent process from being accumulated within the polyimide film and thereby would prevent deformation of the film. Hence, the polyimide laminate of the present disclosure is suitable for use as a flexible substrate in semiconductor applications.

The foregoing description of various embodiments of the disclosure has been presented for purpose of illustration and description. It is not intended to be exhaustive or to limit the disclosure to the precise embodiments disclosed. Numerous modifications or variations are possible in light of the above teachings. The embodiments discussed were chosen and described to provide the best illustration of the principles of the disclosure and its practical application to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A method of fabricating a polyimide laminate, comprising:
forming a polyimide film having a thermally conductive filler distributed homogeneously therein with the thermally conductive filler being about 10-90% by weight of the polyimide solid and thereby rendering the polyimide film having a thermal conductivity greater than 0.3 W/m-° C.; and
forming at least one metal layer on one side of the polyimide film.

2. The method of claim 1, wherein the at least one metal layer comprises a metal that is selected from a group consisting of Pd, Cu, Al, Fe, Ni and a combination thereof.

3. The method of claim 2, wherein the at least one metal layer is formed by electroplating, electroless plating, sputter deposition, vapor deposition or lamination on one side of the polyimide film.

4. The method of claim 3, wherein a layer of Pd formed by electroless plating and a layer of Cu formed by electroplating are deposited in sequence on one side of the polyimide film.

5. The method of claim 3, wherein a layer of Ni and a layer of Cu respectively formed by sputter deposition, and another layer of Cu formed by electroplating are deposited in sequence on one side of the polyimide film.

6. The method of claim 3, wherein a layer of Ni formed by vapor deposition, and a layer of Cu formed by electroplating are deposited in sequence on one side of the polyimide film.

7. The method of claim 3, wherein a layer of Cu is laminated on one side of the polyimide film.

8. The method of claim 2, further comprising forming the at least one metal layer on the other side of the polyimide film.

9. The method of claim 8, wherein the at least one metal layer is formed by electroplating, electroless plating, sputter deposition, vapor deposition or lamination on the other side of the polyimide film.

10. The method of claim 9, wherein a layer of Pd formed by electroless plating and a layer of Cu formed by electroplating are respectively deposited in sequence on both sides of the polyimide film.

11. The method of claim 9, wherein a layer of Ni and a layer of Cu respectively formed by sputter deposition, and another layer of Cu formed by electroplating are respectively deposited in sequence on both sides of the polyimide film.

12. The method of claim 9, wherein a layer of Ni formed by vapor deposition, and a layer of Cu formed by electroplating are respectively deposited in sequence on both sides of the polyimide film.

13. The method of claim 9, wherein a layer of Cu is laminated respectively on each side of the polyimide film.

14. The method of claim 1, wherein the thermally conductive filler has a thermal conductivity of greater than 10 W/m-° C. and is any of metal oxide, metal nitride, carbon, silicon carbide (SiC) or ceramic powders.

15. The method of claim 14, wherein the metal oxide is aluminum oxide.

16. The method of claim 14, wherein the metal nitride is any of aluminum nitride, boron nitride, a sintered form thereof or a combination thereof.

17. A polyimide laminate produced by the method of claim 3.

18. A polyimide laminate produced by the method of claim 9.
